(19) United States
(12) Patent Application Publication
(10) Pub. No.: US 2025/0131146 A1
(43) Pub. Date: Apr. 24, 2025

(54) METHOD FOR SIMULATING PERFORMANCE OF LNG AMBIENT AIR VAPORIZER UNDER FROSTING CONDITION

(71) Applicant: NORTH CHINA MUNICIPAL ENGINEERING DESIGN & RESEARCH INSTITUE CO., LTD., Tianjin (CN)

(72) Inventors: Wenxue GAO, Tianjin (CN); Yingjie Hu, Tianjin (CN); Yan Wang, Tianjin (CN); Rongsong Yan, Tianjin (CN); Lin Yang, Tianjin (CN); Qingwei Miao, Tianjin (CN); Mingchang Yang, Tianjin (CN)

(21) Appl. No.: 18/804,653

(22) Filed: Aug. 14, 2024

(30) Foreign Application Priority Data
Oct. 18, 2023 (CN) 2023113494969

(51) Int. Cl. G06F 30/17; F17C 9/02

(52) U.S. Cl. CPC G06F 30/17; F17C 9/02; F17C 2221/033; F17C 2250/032; F17C 2250/043; F17C 2250/0439; F17C 2250/046

(57) ABSTRACT

The present disclosure discloses a method for simulating performance of an LNG ambient air vaporizer under a frosting condition, performing site operation test on the LNG ambient air vaporizer to obtain fitting relationship between the outer wall temperature of frosted finned tube and frost layer; transforming a sum of increased frost layer thermal resistance and thermal resistance into equivalent thermal contact resistance, and representing the equivalent thermal contact resistance as a function of the outer wall temperature; establishing a calculation model of the LNG ambient air vaporizer, performing simulation calculation by equivalent heat conduction coefficient, so as to obtain fluid-solid conjugate heat transfer characteristics and vaporization performance of the LNG ambient air vaporizer under the frosting condition. The influences of heat transfer in gas-liquid phase change flow and fluid-solid conjugate heat transfer in the tubes of the vaporizer under the frosting condition are considered in the present disclosure.

### CROSS-REFERENCE TO RELATED APPLICATION

This application claims priority from the Chinese patent application 2023113494969 filed Oct. 18, 2023, the content of which is incorporated herein in the entirety by reference.

### TECHNICAL FIELD

The present disclosure belongs to methods for simulating performance of low-temperature heat exchange equipment, and particularly relates to a method for simulating performance of an LNG ambient air vaporizer under a frosting condition.

### BACKGROUND

An LNG (liquefied natural gas) ambient air vaporizer is low-temperature heat exchange equipment that absorbs heat from air and transmits the heat to low-temperature LNG in tubes so as to vaporize the LNG into NG (natural gas) through phase change. Compared with vaporizers of other types, the LNG ambient air vaporizer is simple in structure and good in economical efficiency, meets the requirements of energy conservation and environmental protection, and is widely applied to LNG receiving stations and vaporizing stations. However, outer surfaces of finned tubes of the LNG ambient air vaporizer are easily affected by ambient air temperature and humidity, surrounding ambient temperature is reduced due to the absorption of surrounding heat during vaporization, and surfaces of the finned tubes frost, which affects the heat exchange effect and vaporization performance of the vaporizer; and in a severe case, the vaporizer may be non-uniformly stressed, and lateral tension is generated, resulting in pipeline breakage and LNG leakage, which leads to safety accidents.

The reason for frosting of the surfaces of the finned tubes of the LNG ambient air vaporizer is mainly that water vapor in air is formed into solid crystals through phase change, and geometric structures and stacking rules of the solid crystals change with the progress of frosting, which is a complex heat and mass transfer process; in the past performance simulation for the LNG ambient air vaporizer, the effect of frosting on the vaporizer was generally ignored, and ambient air was simplified as dry air ideal gas; and during actual operation of the vaporizer, frosting has a non-negligible effect on performance of the LNG ambient air vaporizer, which will directly reduce a heat transfer coefficient of an air side by up to 85%. Currently, research on the frosting performance of the LNG ambient air vaporizer falls into two main categories. One approach focuses on unstable-state frosting numerical simulation analysis for a local region of a single fin. Although some models can accurately predict the growth situation of a frost layer, the models cannot be applied to simulation of the whole vaporizer considering the complexity of these models, calculation duration and convergence of calculation results; and the other approach is to establish frosting heat transfer mathematical models to determine the influence of the frost layer on the total heat transfer coefficient of the ambient air vaporizer over different frosting times through numerical calculation. However, this method only calculates the overall performance change of the ambient air vaporizer under a frosting condition and neglects interactions between different finned tubes. Consequently, it cannot analyze the heat transfer performance of the different finned tubes or low-temperature media inside the tubes of the vaporizer. CN112580272A has provided an optimal design method of an LNG ambient air vaporizer based on numerical simulation. The method includes the steps: firstly, primarily designing the LNG ambient air vaporizer by adopting methods such as an empirical formula, and then simulating the primarily designed ambient air vaporizer by adopting Fluent software. Although the influence of the number of finned tubes on heat exchange efficiency of the vaporizer is considered in the method, the method cannot calculate the performance of the vaporizer under a frosting condition when treating ambient air as dry air. CN115114815A has provided a simulation method for predicting cold surface frosting by using surface properties of frost layers. The method includes the steps: establishing a calculation model for a condition of frosting over a flat plate through Eulerian multi-phase, performing repeated iterative calculations to solve a control equation for a calculation domain through user-defined functions (UDF) to simulate a growth of the frost layers. However, the method can only simulate frosting degrees of the frost layers in local regions of the flat plate, but cannot obtain the performance change of overall heat exchange equipment in a frosting state. In addition, frosting mainly occurs in a liquid phase section and a two-phase section, the influence of fluid-solid conjugate heat transfer needs to be considered during simulation calculation in the frosting state, however, there is no technical method to explain it.

### SUMMARY

The present disclosure aims at providing a method for simulating performance of an LNG ambient air vaporizer under a frosting condition to overcome the defects in the prior art. Interactions between different finned tubes and the influence of frosting of the finned tubes are considered, heat transfer in gas-liquid phase change flow and fluid-solid conjugate heat transfer in the tubes of the vaporizer are coupled, as a result, models are more realistic, and simulation calculation results are more accurate; and a transient process of frosting of the finned tubes is simplified into a quasi-stable state process, and the method can save a large amount of calculation duration and is high in calculation efficiency and reliability.

A method for simulating performance of an LNG ambient air vaporizer under a frosting condition, includes the following steps:
step 1, performing site operation test on the LNG ambient air vaporizer, measuring site ambient temperature T₀, humidity H₀ and atmospheric pressure P₀, and measuring, at a certain operating moment tₙ, pressure Pᵢₙ of liquefied natural gas at a vaporizer inlet and pressure Pₒᵤₜ of natural gas at a vaporizer outlet, flow velocity Vᵢₙ of the liquefied natural gas at the vaporizer inlet and temperature Tᵢₙ of the liquefied natural gas at the vaporizer inlet, outer wall temperature Tₛ at different positions of each frosted finned tube of the vaporizer, frost layer temperature T_{f}, frost layer thickness d_{f}, and air flow velocity Vₐ outside a frost layer on a surface of the finned tube, the different positions referring to at least three equidistant point positions of an outer wall of a fin of each frosted finned tube from top to bottom;
step 2, performing, by data processing software, fitting analysis on the collected frost layer temperature T_{f} and frost layer thickness d_{f} at the different positions of all the frosted finned tubes at the certain operating moment tₙ and the air flow velocity Vₐ outside the frost layer on the surface of the finned tube, and data of the outer wall temperature Tₛ of the finned tube respectively, and obtaining, by a least square method, fitting relational expressions d_{f}=f_{d}(Tₛ)=A₁Tₛ²+B₁Tₛ+C₁, T_{f}=f_{T}(Tₛ)=A₂Tₛ+B₂, and Vₐ=f_{V}(Tₛ)=A₃Tₛ²+B₃Tₛ+C₃ between the outer wall temperature Tₛ of all the frosted finned tubes of the whole vaporizer and the frost layer thickness d_{f}, the frost layer temperature T_{f} and the air flow velocity Vₐ outside the frost layer on the surface of the finned tube at the certain operating moment tₙ, A₁, B₁, C₁, A₂, B₂, A₃, B₃, and C₃ in the formula being respectively fitted constants;
step 3, establishing a calculation model for an equivalent thermal conductivity coefficient of the LNG ambient air vaporizer at the certain operating moment tₙ under frost conditions: transforming a sum of increased frost layer thermal resistance R_{f} of each frosted finned tube in unit length at the certain operating moment tₙ and thermal resistance Rₒ of the finned tube body in unit length into equivalent thermal contact resistance Rₑ of the finned tube in unit length under a non-frosting condition, and representing an equivalent thermal conductivity coefficient λₑ of the equivalent thermal contact resistance Rₑ as a function of the outer wall temperature Tₛ of the frosted finned tube in unit length, the unit length being a length of a minimum mesh during geometric meshing of the vaporizer; wherein

$${λ}_{e} = F ( {T}_{s} ) = \frac{1}{\frac{1}{λ} + \frac{1}{{d}_{in} ln \frac{{d}_{out}}{{d}_{in}}} \cdot \frac{Z ( {T}_{s} )}{\frac{{A}_{2}^{′} β}{{A}_{2}} + \frac{{A}_{2}^{″} β}{{A}_{2}} \cdot \frac{th ( {A}_{m} \sqrt{{f}_{V} ( {T}_{s} )} )}{{A}_{m} \sqrt{{f}_{V} ( {T}_{s} )}}}}$$

wherein, parameters λ, dᵢₙ, dₒᵤₜ, A₂, A₂, A₂″, Aₘ, and β in the formula are all constant values; λ is a thermal conductivity coefficient of a vaporizer material, namely aluminum alloy; dᵢₙ is an internal diameter of the finned tube, and dₒᵤₜ is an external diameter of the finned tube; A₂ is an external surface area of the finned tube in unit length; A₂ is a surface area of a non-fin part outside the finned tube in unit length; A₂″ is a surface area of a fin part outside the finned tube in unit length; Aₘ=l*[36/(λ*δ)]^{1/2}, where l is a fin height, and δ is a thickness of the fin; β is a finning coefficient of the finned tube, β+A₀/A₂, A₀ is an internal surface area of the finned tube, and A₂ is an external surface area of the finned tube; f_{V}(Tₛ) is a function expression relational expression of the air flow velocity Vₐ outside the frost layer, Vₐ=f_{V}(Tₛ), and Tₛ is the outer wall temperature at different positions of each frosted finned tube of the vaporizer; and Z(Tₛ) is a function expression relational expression of the frost layer thermal resistance R_{f}, R_{f}=Z(Tₛ)=d_{f}/λ_{f}=f_{d}(Tₛ)/g(Tₛ), where, g(Tₛ) is a function expression relational expression of the frost layer thermal conductivity coefficient λ_{f}, λ_{f}=g(Tₛ)=0.001202×(650e^{0.277[(f}^{_{T}}^{(T}^{ₛ}^{)-273.15)]})^{0.963};
step 4, establishing an overall geometric model of the LNG ambient air vaporizer in simulation software, performing meshing and dividing of computational domain, selecting physical models and equations, setting material attributes and boundary conditions of the computational domain, adopting the equivalent thermal conductivity coefficient λₑ of the finned tube of the vaporizer as the thermal conductivity coefficient during frosting of the vaporizer material, performing solving and initialized setting, and then performing simulation calculation, specifically as follows:
S1: establishing, by three-dimensional geometric modeling software, the overall geometric model of the LNG ambient air vaporizer in a ratio of 1:1, and then performing, by finite element meshing software, meshing and dividing of the computational domain of the overall geometric model; dividing the computational domain into an LNG fluid domain, a vaporizer solid domain and an air fluid domain; the LNG fluid domain is a flow region of LNG in an internal channel of the vaporizer; the vaporizer solid domain is a vaporizer body; and the air fluid domain is an air flow region outside the vaporizer body;
S2: importing the meshed overall geometric model of the LNG ambient air vaporizer into fluid analysis software, and adopting the LNG fluid domain, the vaporizer solid domain and the air fluid domain as the computational domain; setting a contact surface between the LNG fluid domain and the vaporizer solid domain and a contact surface between the vaporizer solid domain and the air fluid domain as Interface surfaces, and checking a Couple option in Interface setting, so that the corresponding contact surface can complete heat transfer;
S3: enabling a gravity model, a multi-phase model, a turbulence model, a boiling phase change model, a continuity equation, a momentum equation, an energy equation and a component transport equation in the fluid analysis software, and adopting a standard wall function method for near-wall processing; adopting a Mixture model as the multi-phase model; adopting a Realizable k-& turbulence model as the turbulence model, and adopting an evaporation-condensation Lee model as the boiling phase change model;
S4: setting the material attributes of the computational domain: respectively introducing LNG and NG fluid materials in the fluid analysis software, then setting the LNG fluid material as a first term in the multi-phase model, setting phase change from LNG to NG, and selecting the evaporation-condensation Lee model for a reaction mechanism; introducing an aluminum alloy solid material in the fluid analysis software, adopting physical data in a software material library as parameters of the aluminum alloy solid material, then modifying the thermal conductivity coefficient of the aluminum alloy solid material from the constant value λ to a value represented by a piecewise polynomial temperature function method, setting the thermal conductivity coefficient of the vaporizer material within a frosting temperature range as the equivalent thermal conductivity coefficient λₑ=F(Tₛ), and setting the thermal conductivity coefficient of the vaporizer material within a non-frosting temperature range as the constant value λ; introducing a wet air mixed material in the fluid analysis software, the wet air mixed material including air and water vapor, and physical property data in the software material library are adopted as material attributes of the wet air mixed material;
S5: setting the boundary conditions of the computational domain:
setting an outlet of the LNG fluid domain as a pressure outlet boundary, and adopting the pressure Pₒᵤₜ at the vaporizer outlet tested on site as pressure; setting an inlet of the LNG fluid domain as a velocity inlet boundary, and adopting the flow velocity Vᵢₙ and temperature Tᵢₙ at the vaporizer inlet tested on site as velocity and temperature; setting a top surface of the air fluid domain above the vaporizer and a side surface of the air fluid domain around the vaporizer as pressure inlet boundaries, adopting the atmospheric pressure P₀ and ambient temperature T₀ tested on site as pressure and temperature, and setting air humidity of the air fluid domain for simulating the air humidity according to the ambient humidity tested on site; setting a bottom surface of the air fluid domain at a bottom of the vaporizer as a pressure outlet boundary;
defining the air fluid domain in this step as a hexahedron capable of surrounding the vaporizer, space, except for the vaporizer, inside the hexahedron representing air outside the vaporizer, and the top surface, the side surface and the bottom surface of the air fluid domain referring to a top surface, a side surface and a bottom surface of the hexahedron outside the whole vaporizer;
S6: performing initialization setting by adopting a SIMPLE algorithm in the fluid analysis software as a solving method for the geometric model meshes divided in step S1, and then performing calculation simulation on the geometric model established in step S1; stopping calculation and outputting result data from numerical simulation in heat transfer of the vaporizer if a residual variance curve converges and the monitored NG outlet temperature and flow velocity do not change any more; or else, continuing to operate; and
step 5, importing the result data from numerical simulation into post-processing software for analysis, displaying a temperature cloud diagram on a surface of the LNG ambient air vaporizer, and a temperature cloud diagram, a velocity cloud diagram and a component cloud diagram of the LNG fluid domain in the tube of the vaporizer in the post-processing software, selecting an outlet section of the LNG fluid domain, to obtain LNG outlet temperature and outlet flow velocity, and selecting the component cloud diagram of the LNG fluid domain, to obtain proportions of a liquid phase section, a two-phase section and a gas-phase section in the fluid domain; and checking temperature, heat flux and other thermal parameters at different position points or sections of the surface of the vaporizer, so as to visually acquire fluid-solid conjugate heat transfer characteristics and vaporization performance of the LNG ambient air vaporizer under the frosting condition.

The present disclosure has the beneficial effects:

1. According to the method for simulating the performance of the LNG ambient air vaporizer under the frosting condition provided by the present disclosure, the transient process of frosting of the finned tubes is simplified into the quasi-stable-state process, that is, it is considered that the process is stable in a certain operating time step length; the sum of the increased frost layer thermal resistance at different operating moments under the frosting condition and the thermal resistance of the finned tube body is transformed into the equivalent thermal contact resistance of the materials of the finned tubes of the vaporizer under the non-frosting condition, and the thermal conductivity coefficient of the equivalent thermal contact resistance of the finned tubes is represented as the function of the outer wall temperature of the finned tubes; and by means of the method, simulation for overall performance of the vaporizer in the frosting state is achieved, the interactions between the different finned tubes are considered, the simulation results are more accurate, the simulation calculation duration can be greatly shortened, and the simulation efficiency is improved.

2. According to the method for simulating the performance of the LNG ambient air vaporizer under the frosting condition provided by the present disclosure, the influences of heat transfer in gas-liquid phase change flow and fluid-solid conjugate heat transfer in the tubes of the vaporizer on the performance of the vaporizer under the frosting condition are considered, the models are more realistic, the simulation calculation results are more accurate, and the method can be used for simulation research on the heat transfer performance and the vaporization performance of the vaporizer under the frosting condition and design optimization for the vaporizer, and has good practicality.

### BRIEF DESCRIPTION OF THE DRAWINGS

Drawings of the specification constituting a part of the present disclosure are described for further understanding the present disclosure. Schematic embodiments of the present disclosure and descriptions thereof are schematic of the present disclosure, and are not construed as an improper limitation to the present disclosure.

FIG. 1 is a flowchart of a method for simulating performance of an LNG ambient air vaporizer under a frosting condition according to the present disclosure;

FIG. 2 is a quarter cross-section diagram of a finned tube of an LNG ambient air vaporizer used for performance simulation under a frosting condition according to the present disclosure;

FIG. 3 is a principle diagram of transforming a sum of frost layer thermal resistance R_{f} and thermal resistance Rₒ of a finned tube body into an equivalent thermal contact resistance Rₑ of the finned tube adopting a method for simulating performance of an LNG ambient air vaporizer under a frosting condition according to the present disclosure;

FIG. 4 is a schematic diagram of a relationship between frost layer thermal resistance R_{f} at different positions of a finned tube and outer wall temperature Tₛ of the finned tube adopting a method for simulating performance of an LNG ambient air vaporizer under a frosting condition according to the present disclosure;

FIG. 5 is a diagram of a fitting curve of frost layer thermal resistance and outer wall temperature of a finned tube at different operating times adopting a method for simulating performance of an LNG ambient air vaporizer under a frosting condition according to the present disclosure;

FIG. 6 is a schematic diagram of a geometric model of a vaporizer adopting a method for simulating performance of an LNG ambient air vaporizer under a frosting condition according to the present disclosure;

FIG. 7 is a top view of the geometric model of the vaporizer shown in FIG. 6;

FIG. 8 is a front view of the geometric model of the vaporizer shown in FIG. 6;

FIG. 9 is a side view of the geometric model of the vaporizer shown in FIG. 6;

FIG. 10 is a schematic diagram of meshing of a geometric model of a vaporizer adopting a method for simulating performance of an LNG ambient air vaporizer under a frosting condition according to the present disclosure;

FIG. 11 is a proportion comparison diagram of liquid phase sections, two-phase sections and gas liquid sections in branch tubes of different vaporizer finned tubes in a method for simulating performance of an LNG ambient air vaporizer under a frosting condition according to the present disclosure; and

FIG. 12 is a comparison diagram of simulation results versus actual measurement results of vaporizer outlet temperature at different operating times in a method for simulating performance of an LNG ambient air vaporizer under a frosting condition according to the present disclosure.

In the drawings, 1: frost layer outside fin; 2: finned tube of vaporizer; and 3: LNG.

### DETAILED DESCRIPTION OF THE PRESENT DISCLOSURE

It should be noted that the following detailed descriptions are exemplary, which are intended to further explain the present application. Unless otherwise indicated, all technical and scientific terms used herein have the same meaning as commonly understood by those ordinarily skilled in the prior art to which the present application pertains.

It should be noted that the terms used here are not intended to limit the exemplary implementations according to the present application, but are merely descriptive of the specific implementations. Unless otherwise directed by the context, singular forms of terms used here are intended to include plural forms. Besides, it should be also appreciated that, when the terms “comprise” and/or “include” are used in the specification, it is indicated that characteristics, steps, operations, devices, assemblies, and/or combinations thereof exist.

Additionally, any directional indication (such as upper, lower, left, right, front, back, or the like) involved in the embodiments of the present disclosure is only used for explaining relative position relations, movement conditions and the like of components in a certain specific posture (as shown in figures). If the specific posture changes, the directional indications may change accordingly.

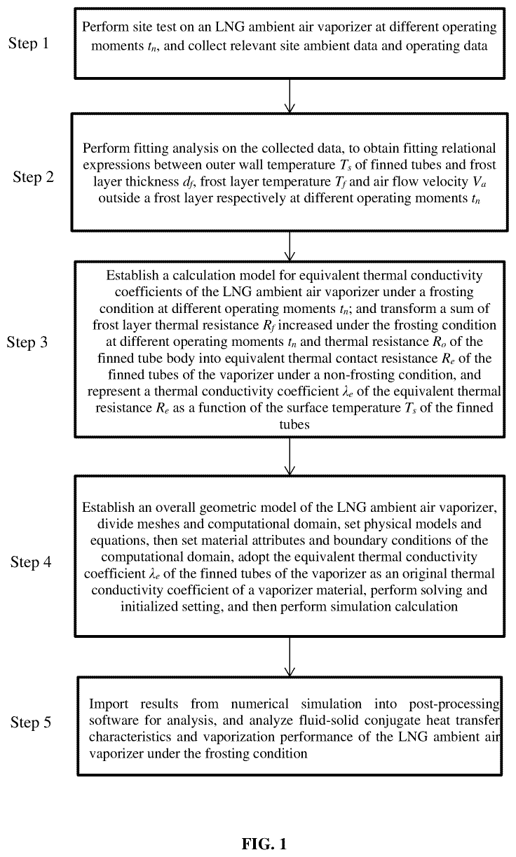

As shown in FIG. 1, a method for simulating performance of an LNG ambient air vaporizer under a frosting condition according to the present disclosure, includes the following steps:

step 1, site operation test is performed on the LNG ambient air vaporizer, site ambient temperature T₀, humidity H₀ and atmospheric pressure P₀ are measured, and pressure Pᵢₙ of liquefied natural gas at a vaporizer inlet and pressure Pₒᵤₜ of natural gas at a vaporizer outlet, flow velocity Vᵢₙ of the liquefied natural gas at the vaporizer inlet and temperature Tᵢₙ of the liquefied natural gas at the vaporizer inlet, outer wall temperature Tₛ at different positions of each frosted finned tube of the vaporizer, frost layer temperature T_{f}, frost layer thickness d_{f}, and air flow velocity Vₐ outside a frost layer on a surface of the finned tube at a certain operating moment tₙ (such as 1 h, 2 h, 4 h or 8 h) are measured, the different positions referring to at least three equidistant point positions of an outer wall of a fin of each frosted finned tube from top to bottom;
step 2, fitting analysis is performed on the collected frost layer temperature T_{f} and frost layer thickness d_{f} at the different positions of all the frosted finned tubes at the certain operating moment tₙ and the air flow velocity Vₐ on the outer side of the frost layer on the surface of the finned tube, and data of the outer wall temperature Tₛ of the finned tube respectively is performed by data processing software (such as SPSS or Origin), and fitting relational expressions d_{f}=f_{d}(Tₛ)=A₁Tₛ²+B₁Tₛ+C₁, T_{f}=f_{T}(Tₛ)=A₂Tₛ+B₂, and Vₐ=f_{V}(Tₛ)=A₃Tₛ²+B₃Tₛ+C₃ between the outer wall temperature Tₛ of all the frosted finned tubes of the whole vaporizer and the frost layer thickness d_{f}, the frost layer temperature T_{f} and the air flow velocity Vₐ outside the frost layer on the surface of the finned tube at the certain operating moment tₙ are obtained by a least square method, A₁, B₁, C₁, A₂, B₂, A₃, B₃, and C₃ in the formulas being respectively fitted constants.

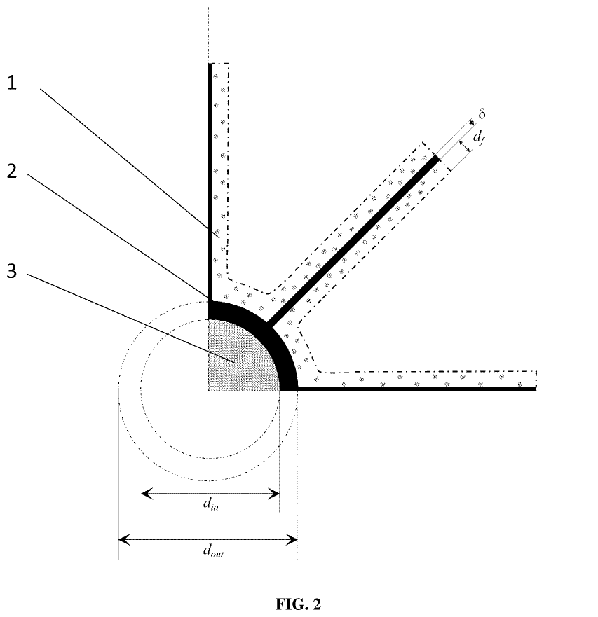

In this step, a relationship between the outer wall temperature of each frosted finned tube and the frost layer thickness are integrated to fit a relational expression, that is, data of all the finned tubes at the same operating time t, is collected, the data of all the frosted finned tubes of the vaporizer is fitted, and each relational expression (all the finned tubes are fitted in this relational expression) of d_{f}=f_{d}(Tₛ); T_{f}=f_{T}(Tₛ); Vₐ=f_{V}(Tₛ) is fitted; and different relational expressions may correspond to different operating times. Since temperature distribution of each finned tube is different, a temperature distribution range can be widened by collecting the data of all the finned tubes, which is conducive to improving fitting accuracy. FIG. 2 is a quarter cross-section diagram of a finned tube of an LNG ambient air vaporizer used for performance simulation under a frosting condition according to the present disclosure, which shows the frost layer thickness d_{f}, an external diameter dₒᵤₜ of the finned tube, an internal diameter dᵢₙ of the finned tube, and a thickness δ of a fin.

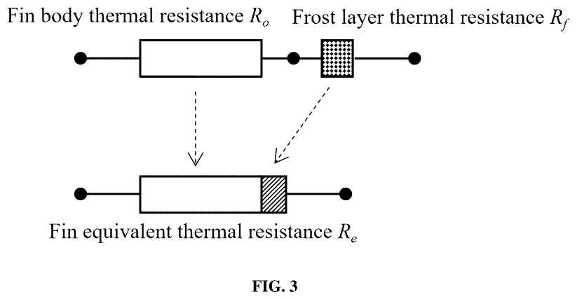

Step 3, a calculation model for an equivalent thermal conductivity coefficient, of the LNG ambient air vaporizer during frosting at the certain operating moment tₙ is established: as shown in FIG. 3, a sum of increased frost layer thermal resistance R_{f} of each frosted finned tube in unit length(the unit length is a length of a minimum mesh during geometric meshing of the vaporizer) at the certain operating moment tₙ and thermal resistance Rₒ of the finned tube body in unit length is transformed into equivalent thermal contact resistance Rₑ of the finned tube in unit length under a non-frosting condition, and an equivalent thermal conductivity coefficient λₑ of the equivalent thermal contact resistance Rₑ is represented as a function of the outer wall temperature Tₛ of the frosted finned tube in unit length:

$${λ}_{e} = F ( {T}_{s} ) = \frac{1}{\frac{1}{λ} + \frac{1}{{d}_{in} ln \frac{{d}_{out}}{{d}_{in}}} \cdot \frac{Z ( {T}_{s} )}{\frac{{A}_{2}^{′} β}{{A}_{2}} + \frac{{A}_{2}^{″} β}{{A}_{2}} \cdot \frac{th ( {A}_{m} \sqrt{{f}_{V} ( {T}_{s} )} )}{{A}_{m} \sqrt{{f}_{V} ( {T}_{s} )}}}} .$$

wherein, parameters λ, dᵢₙ, dₒᵤₜ, A₂, A₂′, A₂″, Aₘ, and β in the formula are all constant values; λ is a thermal conductivity coefficient of a vaporizer material, namely aluminum alloy, W/(m·K), which can be found in professional books (such as Practical Handbook of Nonferrous Metal Materials, Guangdong Science and Technology Press, 2006); dᵢₙ is the internal diameter of the finned tube, and dₒᵤₜ is the external diameter of the finned tube, m, which can be obtained through a design drawing; A₂ is an external surface area of the finned tube in unit length, m²; A₂ is a surface area of a non-fin part outside the finned tube in unit length, m²; A₂″ is a surface area of a fin part outside the finned tube in unit length, m²; A₂, A₂, and A₂″ can be calculated from the design drawing; Aₘ=!*[36/(λ*δ)]^{1/2}, where l is a fin height, δ is the thickness of the fin, and m, l, and δ can be obtained from the design drawing; β is a finning coefficient of the finned tube, βA₀/A₂, A₀ is an internal surface area of the finned tube, and A₂ is an external surface area of the finned tube, m², which can be calculated from the design drawing. f_{V}(Tₛ) is a function expression relational expression of the air flow velocity Vₐ outside the frost layer, and Tₛ is the outer wall temperature K at different positions of each frosted finned tube of the vaporizer; and Z(Tₛ) is a function expression relational expression of the frost layer thermal resistance R_{f}, R_{f}=Z(Tₛ)=d_{f}/λ_{f}=f_{d}(Tₛ)/g(Tₛ), where, g(Tₛ) is a function expression relational expression of the frost layer thermal conductivity coefficient λ_{f}, λ_{f}=g(Tₛ)=0.001202×(650e^{0.277[(f}^{_{T}}^{(T}^{ₛ}^{)-273.15)]})^{0.963}.

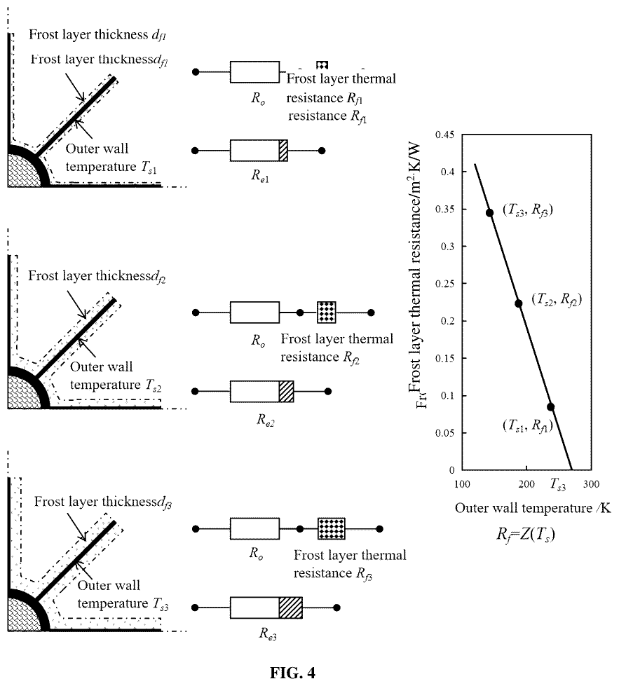

Since the outer wall temperature Tₛ and the frost layer thickness d_{f} on each section of the finned tube are different, the frost layer thermal resistance Rₑ of the finned tube in unit length is also different (as shown in FIG. 4), the relational expression is established between the frost layer thermal resistance R_{f} and Tₛ, and the frost layer thermal resistance R_{f} in each section of the finned tube in unit length may be represented by the outer wall temperature Tₛ of the finned tube; therefore, the increased frost layer thermal resistance Rₑ of the whole finned tube is not a constant value for each section any more, but is a linear value changing with the outer wall temperature Tₛ of each section of the finned tube; finally, the thermal conductivity coefficient λₑ of the equivalent thermal contact resistance Rₑ of the frosted finned tube is represented as the function of the outer wall temperature Tₛ of the finned tube; and the increased frost layer thermal resistance R_{f} in each section of each finned tube in unit length and the thermal conductivity coefficient we are different, however, the thermal conductivity coefficients of all the sections are calculated through the function relational expression λₑ=F(Tₛ).

A deduction process of the function relational expression. λₑ=F(Tₛ) of the thermal conductivity coefficient λₑ of the equivalent thermal contact resistance Rₑ of the frosted finned tube and the outer wall temperature Tₛ of the frosted finned tube is as follows:

Firstly, let a total heat transfer coefficient K_{f} (the total heat transfer coefficient is obtained according to a calculation formula for a heat transfer process through a ribbed wall in Heat Transfer 5th Edition (Higher Education Press, 2019) be equivalent to a total heat transfer coefficient K of the finned tube under a non-frosting condition, and then an expression of the equivalent thermal conductivity coefficient λₑ of the vaporizer material, namely aluminum alloy is obtained through transposition, as follows:

$$\frac{1}{\frac{1}{{h}_{in}} + \frac{{d}_{in}}{λ} ln \frac{{d}_{out}}{{d}_{in}} + \frac{1}{η \cdot β} ( \frac{1}{{h}_{out}} + {R}_{f} )} = {K}_{f} = K = \frac{1}{\frac{1}{{h}_{in}} + \frac{{d}_{in}}{{λ}_{e}} ln \frac{{d}_{out}}{{d}_{in}} + \frac{1}{η \cdot β \cdot {h}_{out}}}$$

$${λ}_{e} = \frac{1}{\frac{1}{λ} + \frac{1}{{d}_{in} ln \frac{{d}_{out}}{{d}_{in}}} \cdot \frac{{R}_{f}}{η \cdot β}}$$

In the formula, K_{f} is the total heat transfer coefficient of the finned tube of the LNG ambient air vaporizer under the frosting condition, W/(m²·K); K is the total heat transfer coefficient of the finned tube of the LNG ambient air vaporizer under the non-frosting condition, W/(m²·K); hᵢₙ is a surface heat transfer coefficient in the finned tube, W/(m²·K); dᵢₙ is the internal diameter of the finned tube, m; λ is the thermal conductivity coefficient of the vaporizer material, namely aluminum alloy, W/(m· K); dₒᵤₜ is the external diameter of the finned tube, m; η is fin efficiency (the fin efficiency=actual heat dissipating capacity of the surface of the fin/heat dissipating capacity assuming that the outer wall temperature of the fin is equal to fin root temperature); β is a finning coefficient of the finned tube; hₒᵤₜ is a heat transfer coefficient on an air side outside the finned tube, W/(m²·K); R_{f} is the frost layer thermal resistance, (m²·K)/W; and λₑ is the equivalent thermal conductivity coefficient of the vaporizer material, namely the aluminum alloy, W/(m·K).

Parameter λ can be obtained in professional books (such as Practical Handbook of Nonferrous Metal Materials, Guangdong Science and Technology Press, 2006); dᵢₙ and dₒᵤₜ can be obtained from the design drawing; η, β, hₒᵤₜ, and R_{f} can be calculated through the following formula; and hᵢₙ is eliminated in calculation, which does not need to be solved.

The heat transfer coefficient hₒᵤₜ on the air side outside the finned tube is represented as an additive value of a convection heat exchange coefficient h_{out,d} on the air side outside the tube and a radiation heat exchange coefficient h_{out,r} on the air side outside the tube: hₒᵤₜ=h_{out,d}+h_{out,r}; and since the outer wall temperature Tₛ of the finned tube has little influence on the convection heat exchange coefficient h_{out,d} on the air side, the heat transfer coefficient can be calculated through the air flow velocity Vₐ on the outer side of the frost layer on the surface of the finned tube measured on site: hₒᵤₜ=18×Vₐ.

A calculation formula of the fin efficiency η is:

$$η = \frac{{A}_{2}^{′} + {A}_{2}^{″} {η}_{f}}{{A}_{2}}$$

In the formula, A₂ is the surface area outside the finned tube, m²; A₂′ is a surface area of a non-fin part outside the finned tube in unit length, m²; A₂″ is a surface area of a fin part outside the finned tube in unit length, m²; A₂, A₂′, and A₂″ can be calculated from the design drawing; and η_{f} is fin surface efficiency, and a calculation formula is:

$${η}_{f} = \frac{th ( m l )}{m l}$$

$$m = \sqrt{\frac{2 {h}_{out}}{λ δ}}$$

In the formula, m is the fin coefficient; l is the fin height, m; λ is the thermal conductivity coefficient of the vaporizer material, namely the aluminum alloy, W/(m·K); δ is the fin thickness, m; both l and δ can be obtained from the design drawing; hₒᵤₜ is the heat transfer coefficient on the air side outside the finned tube, W/(m²·K), when radiation heat exchange on the air side is neglected, hₒᵤₜ can be calculated according to the air flow velocity Vₐ outside the frost layer hₒᵤₜ=18×Vₐ, and hₒᵤₜ is expressed as the function hₒᵤₜ=18×Vₐ=18×f_{V}(Tₛ) with the outer wall temperature Tₛ of the finned tube according to the fitting relationship Vₐ=f_{V}(Tₛ) between the outer wall temperature Tₛ of the finned tube and the air flow velocity outside the frost layer, m=[2*18*f_{V}(Tₛ)/(λ*δ)]^{1/2}. Let Aₘ=l*[36/(λ*δ)]^{1/2}, then η_{f}=th(Aₘ*f_{V}(Tₛ)^{1/2})/(Aₘ*f_{V}(Tₛ)^{1/2}).

A calculation formula of the finning coefficient 8 of the finned tube is:

$$β = \frac{{A}_{0}}{{A}_{2}}$$

In the formula, A₀ is the internal surface area of the finned tube, m², and A₂ is the external surface area of the finned tube, m², which can be calculated from the design drawing.

A calculation formula of the frost layer thermal resistance R_{f} is:

$${R}_{f} = \frac{{d}_{f}}{{λ}_{f}}$$

In the formula, d_{f} is the frost layer thickness, mm; Δ_{f} is the frost layer thermal conductivity coefficient, W/(m· K), which mainly depends on frost layer density ρ_{f} and can be calculated through Sanders relational expression (reference: Seker D, Karatas H, Egrican N .Frost formation on fin-and-tube heat exchangers. Part I-Modeling of frost formation on fin-and-tube heat exchangers [J]. International Journal of Refrigeration, 2004, 27 (4): 367-374:

λ_{f}=0.001202ρ_{f}^{0.963}

In the formula, ρ_{f} is the frost layer density, kg/m³; and a calculation formula is as follows:

$${ρ}_{f} = 650 {e}^{0.277 ( {T}_{f} - 273.15 )}$$

In the formula, T_{f} is the frost layer temperature, K.

The above two formulas are combined to obtain a formula of the frost layer thermal conductivity coefficient λ_{f} changing with the frost layer temperature T_{f}, as follows:

The function expression of the frost layer thermal conductivity coefficient is

$${λ}_{f} = 0.001202 \times {( 650 {e}^{0.277 ( {T}_{f} - 273.15 )} )}^{0.963}$$

and the outer wall temperature Tₛ of the finned tube is obtained according to the fitting relational expression T_{f}=f_{T}(Tₛ) between the outer wall temperature Tₛ of the finned tube and the frost layer temperature T_{f}, as follows:

$${λ}_{f} = g ( {T}_{s} ) = 0.001202 \times {( 650 {e}^{0.277 ( {f}_{T} ( {T}_{s} ) - 273.15 )} )}^{0.963}$$

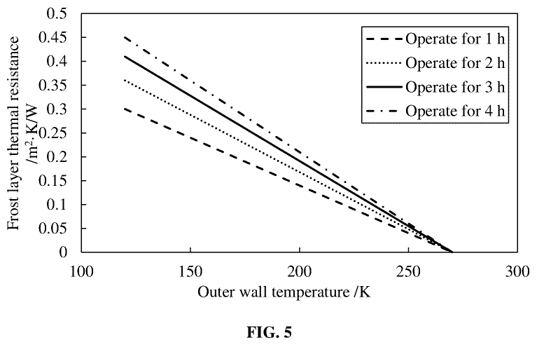

The frost layer thermal resistance R_{f} is expressed as the function R_{f}=d_{f}/λ_{f}=_{d}(Tₛ=f (Tₛ)/g(Tₛ)=Z(Tₛ) of the outer wall temperature Tₛ of the finned tube. FIG. 5 is a diagram of a fitting curve of frost layer thermal resistance R_{f} and the outer wall temperature Tₛ of the finned tube at different operating times.

R_{f}=Z(Tₛ), η=(A₂′+A₂″n_{f})/A₂, and n_{f}=th(Aₘf_{V}(Tₛ)^{1/2})/(Aₘf_{V}(Tₛ)^{1/2}) are substituted into the expression of the equivalent thermal conductivity coefficient λₑ of the vaporizer material, namely the aluminum alloy, to obtain:

$${λ}_{e} = \frac{1}{\frac{1}{λ} + \frac{1}{{d}_{in} ln \frac{{d}_{out}}{{d}_{in}}} \cdot \frac{{R}_{f}}{η \cdot β}} = \frac{1}{\frac{1}{λ} + \frac{1}{{d}_{in} ln \frac{{d}_{out}}{{d}_{in}}} \cdot \frac{Z ( {T}_{s} )}{\frac{{A}_{2}^{′} + {A}_{2}^{″} {n}_{f}}{{A}_{2}} \cdot β}} = \frac{1}{\frac{1}{λ} + \frac{1}{{d}_{in} ln \frac{{d}_{out}}{{d}_{in}}} \cdot \frac{Z ( {T}_{s} )}{\frac{{A}_{2}^{′} β}{{A}_{2}} + \frac{{A}_{2}^{″} β}{{A}_{2}} \cdot \frac{th ( {A}_{m} \sqrt{{f}_{V} ( {T}_{s} )} )}{{A}_{m} \sqrt{{f}_{V} ( {T}_{s} )}}}}$$

In the formula, Δ, dᵢₙ, dₒᵤₜ, A₂, A₂′, A₂″, Aₘ, and β are all constant values; and the equivalent thermal conductivity coefficient λₑ of the finned tube of the vaporizer is expressed as the function λₑ=F(Tₛ) of the outer wall temperature Tₛ of the finned tube.

Step 4, an overall geometric model of the LNG ambient air vaporizer is established in simulation software, meshing and dividing of computational domain are performed, physical models and equations are selected, material attributes and boundary conditions of the computational domain are set, the equivalent thermal conductivity coefficient de of the finned tube of the vaporizer is adopted as the thermal conductivity coefficient during frosting of the vaporizer material, solving and initialization setting are performed, and then simulation calculation is performed. Details are as follows:

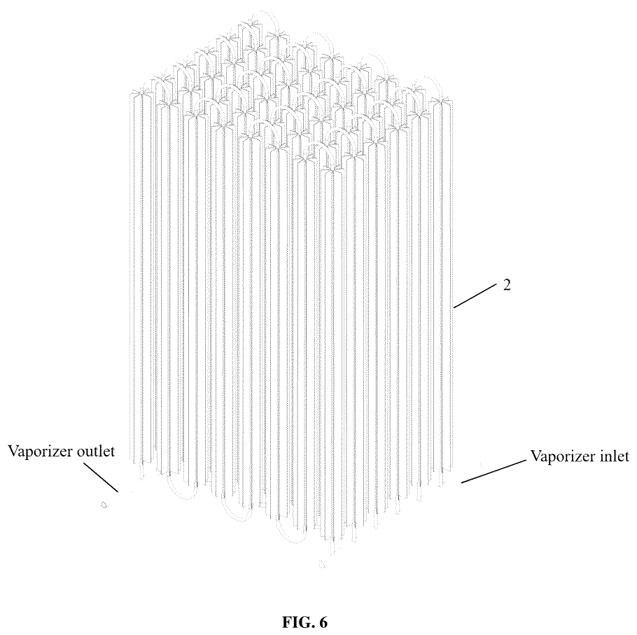

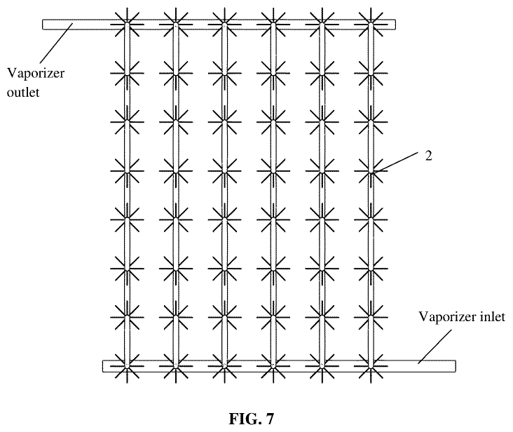

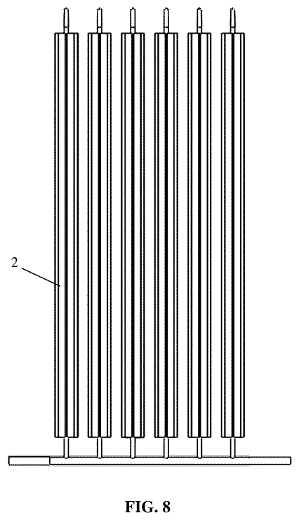

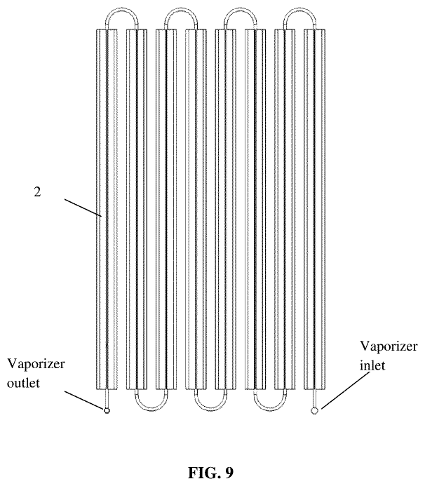

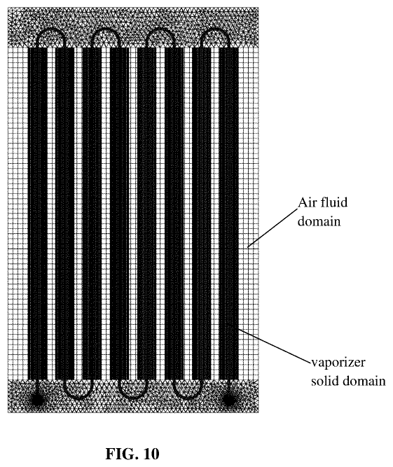

S1: as shown in FIG. 6 to FIG. 9, the overall geometric model of the LNG ambient air vaporizer in a ratio of 1:1 is established through three-dimensional geometric modeling software (such as SolidWorks or ANSYS DesignModeler), then the overall geometric model is subjected to meshing (as shown in FIG. 10, which is a schematic diagram of geometric model meshing through ANSYS Meshing) and dividing of the computational domain through finite element meshing software (such as ICEM CFD or ANSYS Meshing). The meshing needs to take the number, density and quality of meshes into account, so as to improve calculation efficiency and accuracy; the computational domain are divided into an LNG fluid domain, a vaporizer solid domain and an air fluid domain; the LNG fluid domain is a flow region of LNG in an internal channel of the vaporizer; the vaporizer solid domain is a vaporizer body; and the air fluid domain is an air flow region outside the vaporizer body.

S2: the meshed overall geometric model of the LNG ambient air vaporizer is imported into fluid analysis software (such as ANSYS Fluent), and the LNG fluid domain, the vaporizer solid domain and the air fluid domain are adopted as the computational domain; and a contact surface between the LNG fluid domain and the vaporizer solid domain and a contact surface between the vaporizer solid domain and the air fluid domain are set as Interface surfaces, and a Couple option checked set in Interface setting, so that the corresponding contact surface can complete heat transfer.

S3: a gravity model, a multi-phase model, a turbulence model, a boiling phase change model, a continuity equation, a momentum equation, an energy equation and a component transport equation are enabled in the fluid analysis software, and a standard wall function method is adopted for near-wall processing; a Mixture model is adopted as the multi-phase model; and a Realizable k-epsilon turbulence model is adopted as the turbulence model, and an evaporation-condensation Lee model is adopted as the boiling phase change model.

S4: the material attributes of the computational domain are set:

LNG and NG fluid materials are respectively introduced in the fluid analysis software, physical parameter data about LNG and NG in relevant books (Technical Handbook of Liquefied Natural Gas, China Machine Press, 2010) are adopted as material parameters, then the LNG fluid material is set as a first term in the multi-phase model, phase change from LNG to NG is set, and the evaporation-condensation Lee model is selected for a reaction mechanism; an aluminum alloy solid material is introduced in the fluid analysis software, physical data in a software material library is adopted as parameters of the aluminum alloy solid material, then the thermal conductivity coefficient of the aluminum alloy solid material is modified from the constant value λ to a value represented by a piecewise polynomial temperature function method, the thermal conductivity coefficient of the vaporizer material within a frosting temperature range is set as the equivalent thermal conductivity coefficient λₑ=F(Tₛ), and the thermal conductivity coefficient of the vaporizer material with a non-frosting temperature range is set as the constant value λ; and a wet air mixed material is introduced in the fluid analysis software, the wet air mixed material including air and water vapor, and physical property data in the software material library are adopted as material attributes of the wet air mixed material.

S5: the boundary conditions of the computational domain are set:

An outlet of the LNG fluid domain is set as a pressure outlet boundary, and the pressure Pₒᵤₜ at the vaporizer outlet tested on site is adopted as pressure; an inlet of the LNG fluid domain is set as a velocity inlet boundary, and the flow velocity Vᵢₙ and temperature Tᵢₙ at the vaporizer inlet tested on site are adopted as velocity and temperature; a top surface of the air fluid domain above the vaporizer and a side surface of the air fluid domain around the vaporizer are set as pressure inlet boundaries, the atmospheric pressure P₀ and ambient temperature T₀ tested on site are set as pressure and temperature, and air humidity of the air fluid domain for simulating the air humidity is set according to the ambient humidity tested on site; and a bottom surface of the air fluid domain at a bottom of the vaporizer is set as a pressure outlet boundary.

In this step, the air fluid domain is defined as a hexahedron capable of surrounding the vaporizer, space, except for the vaporizer, inside the hexahedron represents air outside the vaporizer, and the top surface, the side surface and the bottom surface of the air fluid domain refer to a top surface, a side surface and a bottom surface of the hexahedron outside the whole vaporizer.

S6: initialization setting is performed by adopting a SIMPLE algorithm in the fluid analysis software as a solving method for the geometric model meshes divided in step S1, and then calculation simulation is performed on the geometric model established in step S1; calculation stops and result data from numerical simulation in heat transfer of the vaporizer is output if a residual variance curve converges and the monitored NG outlet temperature and flow velocity do not change any more; otherwise, it proceeds to operate.

Furthermore, in order to make the initialization result as close as possible to the actual physical result to ensure the stability of the calculation process and increase the convergence velocity, an LNG volume fraction of an inlet of the LNG fluid domain is set as 1 and temperature is set as 123 K through a Patch function in the fluid analysis software; temperature of the vaporizer solid domain is set as 260 K; a volume fraction of air in the air fluid domain outside the finned tube is set as 1, and temperature is determined through a self-defined formula: T=279+7z, where, T is air temperature, K; and z is a height in an z-axis direction (z-axis is set to be perpendicular to the bottom of the vaporizer, which is a vertically upward direction), m.

Step 5, the result data from numerical simulation is imported into post-processing software (such as Tecplot or Ensight) for analysis, a temperature cloud diagram on a surface of the LNG ambient air vaporizer, and a temperature cloud diagram, a velocity cloud diagram and a component cloud diagram of the LNG fluid domain in the tube of the vaporizer are displayed in the post-processing software, an outlet section of the LNG fluid domain is selected, to obtain LNG outlet temperature and outlet flow velocity, and the component cloud diagram of the LNG fluid domain is selected, to obtain proportions of a liquid phase section, a two-phase section and a gas-phase section in the fluid domain; and temperature, heat flux and other thermal parameters at different position points or sections of the surface of the vaporizer are checked, so as to visually acquire fluid-solid conjugate heat transfer characteristics and vaporization performance of the LNG ambient air vaporizer under the frosting condition.

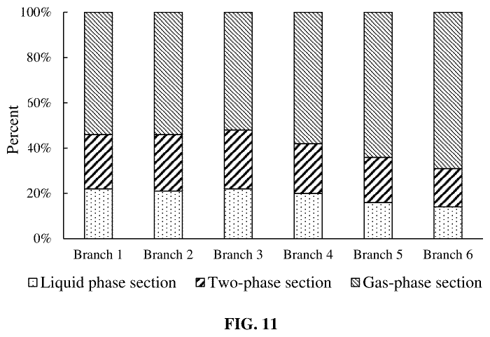

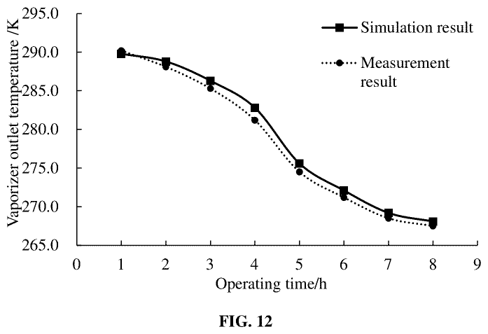

Analysis results are shown in FIG. 11 and FIG. 12, and FIG. 11 shows proportions of liquid phase sections, two-phase sections and gas liquid sections in branch tubes of different vaporizer finned tubes under a frosting condition; and FIG. 12 shows comparison of simulation results versus actual measurement results of vaporizer outlet temperature at different operating times, and it can be shown that errors between the simulation results of the method and the actual measurement results are small, thereby realizing good accuracy.

The above description is only the preferred embodiments of the present application, and is not intended to limit the present application, and for those skilled in the art, the present application may have various modifications and variations. Any modification, equivalent replacement, improvement, etc. made within the spirit and principle of the present application shall fall within the protection scope of the present application.

What is claimed:

1. A method for simulating performance of an LNG ambient air vaporizer under a frosting condition, includes the following steps:
step 1, performing site operation test on the LNG ambient air vaporizer, measuring site ambient temperature T₀, humidity H₀ and atmospheric pressure P₀, and measuring, at a certain operating moment tₙ, pressure Pᵢₙ of liquefied natural gas at a vaporizer inlet and pressure Pₒᵤₜ of natural gas at a vaporizer outlet, flow velocity Vᵢₙ of the liquefied natural gas at the vaporizer inlet and temperature Tᵢₙ of the liquefied natural gas at the vaporizer inlet, outer wall temperature Tₛ at different positions of each frosted finned tube of the vaporizer, frost layer temperature T_{f}, frost layer thickness d_{f}, and air flow velocity Vₐ outside a frost layer on a surface of the finned tube, the different positions referring to at least three equidistant point positions of an outer wall of a fin of each frosted finned tube from top to bottom;
step 2, performing, by data processing software, fitting analysis on the collected frost layer temperature T_{f} and frost layer thickness d_{f} at the different positions of all the frosted finned tubes at the certain operating moment t, and the air flow velocity Vₐ outside the frost layer on the surface of the finned tube, and data of the outer wall temperature Tₛ of the finned tube respectively, and obtaining, by a least square method, fitting relational expressions d_{f}=f_{d}(Tₛ)=A₁Tₛ²+B₁Tₛ+C₁, T_{f}=f (Tₛ)=A₂Tₛ+B₂, and Vₐ=f_{V}(Tₛ)=A₃Tₛ²+B₃Tₛ+C₃ between the outer wall temperature Tₛ of all the frosted finned tubes of the whole vaporizer and the frost layer thickness d_{f}, the frost layer temperature T_{f} and the air flow velocity Vₐ outside the frost layer on the surface of the finned tube at the certain operating moment tₙ, A₁, B₁, C₁, A₂, B₂, A₃, B₃, and C₃ in the formula being respectively fitted constants;
step 3, establishing a calculation model for an equivalent thermal conductivity coefficient of the LNG ambient air vaporizer during frosting at the certain operating moment tₙ:
transforming a sum of increased frost layer thermal resistance R_{f} of each frosted finned tube in unit length at the certain operating moment tₙ and thermal resistance Rₒ of the finned tube body in unit length into equivalent thermal contact resistance Rₑ of the finned tube in unit length under a non-frosting condition, and representing an equivalent thermal conductivity coefficient λₑ of the equivalent thermal contact resistance Rₑ as a function of the outer wall temperature Tₛ of the frosted finned tube in unit length, the unit length being a length of a minimum mesh during geometric meshing of the vaporizer; wherein
$${λ}_{e} = F ( {T}_{s} ) = \frac{1}{\frac{1}{λ} + \frac{1}{{d}_{in} ln \frac{{d}_{out}}{{d}_{in}}} \cdot \frac{Z ( {T}_{s} )}{\frac{{A}_{2}^{′} β}{{A}_{2}} + \frac{{A}_{2}^{″} β}{{A}_{2}} \cdot \frac{th ( {A}_{m} \sqrt{{f}_{V} ( {T}_{s} )} )}{{A}_{m} \sqrt{{f}_{V} ( {T}_{s} )}}}}$$
wherein, parameters λ, dᵢₙ, dₒᵤₜ, A₂, A₂, A₂″, Aₘ, and β in the formula are all constant values; λ is a thermal conductivity coefficient of a vaporizer material, namely aluminum alloy; dᵢₙ is an internal diameter of the finned tube, and dₒᵤₜ is an external diameter of the finned tube; A₂ is an external surface area of the finned tube in unit length; A₂ is a surface area of a non-fin part outside the finned tube in unit length; A₂″ is a surface area of a fin part outside the finned tube in unit length; Aₘ=/*[36/(λ*δ)]^{1/2}, where l is a fin height, and δ is a thickness of the fin; β is a finning coefficient of the finned tube, β=A₀/A₂, A₀ is an internal surface area of the finned tube, and A₂ is an external surface area of the finned tube; f_{V}(Tₛ) is a function expression relational expression of the air flow velocity Vₐ outside the frost layer, Vₐ=f_{V}(Tₛ), and Tₛ is the outer wall temperature at different positions of each frosted finned tube of the vaporizer; and Z(Tₛ) is a function expression relational expression of the frost layer thermal resistance R_{f}, R_{f}=Z(Tₛ)=d_{f}/λf=f (Tₛ)/g(Tₛ), where, g(Tₛ) is a function expression relational expression of the frost layer thermal conductivity coefficient λ_{f}, λ_{f}=g(Tₛ)=0.001202×(650e^{0.277[(f}^{_{T}}^{(T}^{ₛ}^{)-273.15)]})^{0.963};
step 4, establishing an overall geometric model of the LNG ambient air vaporizer in simulation software, performing meshing and dividing of computational domain, selecting physical models and equations, setting material attributes and boundary conditions of the computational domain, adopting the equivalent thermal conductivity coefficient λₑ of the finned tube of the vaporizer as the thermal conductivity coefficient during frosting of the vaporizer material, performing solving and initialized setting, and then performing simulation calculation, specifically as follows:
S1: establishing, by three-dimensional geometric modeling software, the overall geometric model of the LNG ambient air vaporizer in a ratio of 1:1, and then performing, by finite element meshing software, meshing and dividing of the computational domain of the overall geometric model; dividing the computational domain into an LNG fluid domain, a vaporizer solid domain and an air fluid domain; the LNG fluid domain is a flow region of LNG in an internal channel of the vaporizer; the vaporizer solid domain is a vaporizer body; and the air fluid domain is an air flow region outside the vaporizer body;
S2: importing the meshed overall geometric model of the LNG ambient air vaporizer into fluid analysis software, and adopting the LNG fluid domain, the vaporizer solid domain and the air fluid domain as the computational domain; setting a contact surface between the LNG fluid domain and the vaporizer solid domain and a contact surface between the vaporizer solid domain and the air fluid domain as Interface surfaces, and checking a Couple option in Interface setting, so that the corresponding contact surface can complete heat transfer;
S3: enabling a gravity model, a multi-phase model, a turbulence model, a boiling phase change model, a continuity equation, a momentum equation, an energy equation and a component transport equation in the fluid analysis software, and adopting a standard wall function method for near-wall processing; adopting a Mixture model as the multi-phase model; adopting a Realizable k-& turbulence model as the turbulence model, and adopting an evaporation-condensation Lee model as the boiling phase change model;
S4: setting the material attributes of the computational domain:
respectively introducing LNG and NG fluid materials in the fluid analysis software, then setting the LNG fluid material as a first term in the multi-phase model, setting phase change from LNG to NG, and selecting the evaporation-condensation Lee model for a reaction mechanism; introducing an aluminum alloy solid material in the fluid analysis software, adopting physical data in a software material library as parameters of the aluminum alloy solid material, then modifying the thermal conductivity coefficient of the aluminum alloy solid material from the constant value λ to a value represented by a piecewise polynomial temperature function method, setting the thermal conductivity coefficient of the vaporizer material within a frosting temperature range as the equivalent thermal conductivity coefficient λₑ=F(Tₛ), and setting the thermal conductivity coefficient of the vaporizer material within a non-frosting temperature range as the constant value λ; introducing a wet air mixed material in the fluid analysis software, the wet air mixed material including air and water vapor, and physical property data in the software material library are adopted as material attributes of the wet air mixed material;
S5: setting the boundary conditions of the computational domain:
setting an outlet of the LNG fluid domain as a pressure outlet boundary, and adopting the pressure Pₒᵤₜ at the vaporizer outlet tested on site as pressure; setting an inlet of the LNG fluid domain as a velocity inlet boundary, and adopting the flow velocity Vᵢₙ and temperature Tᵢₙ at the vaporizer inlet tested on site as velocity and temperature; setting a top surface of the air fluid domain above the vaporizer and a side surface of the air fluid domain around the vaporizer as pressure inlet boundaries, adopting the atmospheric pressure P₀ and ambient temperature T₀ tested on site as pressure and temperature, and setting air humidity of the air fluid domain for simulating the air humidity according to the ambient humidity tested on site; setting a bottom surface of the air fluid domain at a bottom of the vaporizer as a pressure outlet boundary;
defining the air fluid domain in this step as a hexahedron capable of surrounding the vaporizer, space, except for the vaporizer, inside the hexahedron representing air outside the vaporizer, and the top surface, the side surface and the bottom surface of the air fluid domain referring to a top surface, a side surface and a bottom surface of the hexahedron outside the whole vaporizer;
S6: performing initialization setting by adopting a SIMPLE algorithm in the fluid analysis software as a solving method for the geometric model meshes divided in step S1, and then performing calculation simulation on the geometric model established in step S1; stopping calculation and outputting result data from numerical simulation in heat transfer of the vaporizer if a residual variance curve converges and the monitored NG outlet temperature and flow velocity do not change any more; or else, continuing to operate; and
step 5, importing the result data from numerical simulation into post-processing software for analysis, displaying a temperature cloud diagram on a surface of the LNG ambient air vaporizer, and a temperature cloud diagram, a velocity cloud diagram and a component cloud diagram of the LNG fluid domain in the tube of the vaporizer in the post-processing software, selecting an outlet section of the LNG fluid domain, to obtain LNG outlet temperature and outlet flow velocity, and selecting the component cloud diagram of the LNG fluid domain, to obtain proportions of a liquid phase section, a two-phase section and a gas-phase section in the fluid domain; and checking temperature, heat flux and other thermal parameters at different position points or sections of the surface of the vaporizer, so as to visually acquire fluid-solid conjugate heat transfer characteristics and vaporization performance of the LNG ambient air vaporizer under the frosting condition.

2. The method for simulating performance of an LNG ambient air vaporizer under a frosting condition according to claim 1, wherein, in the step S6 of the step 4, an LNG volume fraction of an inlet of the LNG fluid domain is set as 1 and temperature is set as 123 K through a Patch function in the fluid analysis software; temperature of the vaporizer solid domain is set as 260 K; a volume fraction of air in the air fluid domain outside the finned tube is set as 1, and temperature is determined through a self-defined formula: T=279+7z, where, T is air temperature, K; and z is a height in an z-axis direction, and z-axis is set to be perpendicular to the bottom of the vaporizer, which is a vertically upward direction.
